(19) United States
(12) Patent Application Publication
(10) Pub. No.: US 2016/0137386 A1
(43) Pub. Date: May 19, 2016

(54) CONTAINER AND METHOD FOR THE STORAGE AND EXTEMPORANEOUS RECONSTITUTION OF A MIXTURE OF COMPOUNDS IN FIXED PROPORTIONS

(71) Applicant: CORPORACIÓ SANITÀRIA PARC TAULÍ, Sabadell (ES)

(72) Inventors: Caridad PONTES GARCÍA, Barcelona (ES); Xavier CALVET CALVO, Terrassa (ES)

(73) Assignee: CORPORACIÓ SANITÀRIA PARC TAULÍ, Sabadell (ES)

(21) Appl. No.: 14/900,014

(22) PCT Filed: Jun. 17, 2014
(86) PCT No.: PCT/EP2014/062710

§ 371 Date: Dec. 18, 2015

(30) Foreign Application Priority Data
Jun. 18, 2013 (EP) 13382229.6

(51) Int. Cl. B65D 81/32; A61J 1/20; B65D 43/02; B65B 29/10; B65D 25/04

(52) U.S. Cl. CPC B65D 81/3216; B65B 29/10; B65D 25/04; B65D 43/02; A61J 1/2093

(57) ABSTRACT

A container having a hollow body and an opening; the hollow body having a mixing chamber and a storage zone, wherein the storage zone houses two or more independent sub-containers and said storage zone is situated between the opening and said mixing chamber.

The present invention relates to a container which may be used in packaging of pharmaceutical drugs or for the storage and extemporaneous reconstitution of mixtures in fixed proportions of nutritional, cosmetic or other chemical compounds.

### BACKGROUND

Some drugs must be stored in powdered form because they rapidly lose their chemical characteristics or stability once they are mixed with liquids to form a solution or a suspension. These drugs need to be reconstituted, or mixed with a liquid, called the diluent, before they can be administered.

Furthermore, many chemical compounds react or interact with other compounds, loosing purity and/or producing increasingly toxic effects over time. This limits the possibilities for joint storage of the compounds in liquid, powdered or compact forms.

The aim of the invention is to provide a container for the convenient storage and extemporaneous reconstitution of a number of compounds which need to be used simultaneously in known fixed proportions.

### SUMMARY

In one aspect, the present invention provides a container comprising a hollow body and an opening; wherein said hollow body comprises a mixing chamber and a storage zone, wherein the storage zone houses two or more independent sub-containers and said storage zone is situated between the opening and said mixing chamber.

In this aspect of the invention, a container is provided for the convenient storage and extemporaneous reconstitution of a mixture using two or more constituent compounds, in fixed proportions.

The sub-containers may be stand-alone modules which can each be filled with one or more of the mixture's constituent compounds, in set proportions, at remotely located compound producing facilities. The sub-containers may then be sealed and assembled into the container. The container is then ready for storage and use at a later time or date.

Indeed, the fact that the sub-containers are independent allows them to be handled, filled, sealed, stored, etc. at different locations or facilities, or simply to be filled at different times and in different conditions, without interference between one product/sub-container and another.

As the compounds are not mixed with each other or a diluent, their chemical properties remain unaltered and their storage life may be longer than would be that of the mixed solution.

Furthermore, the use of the container, subject of this invention, will make the administration of complex treatments easier by reducing the number of separate compounds to be administered, and thus, reducing the number of administrations and potential errors or omissions.

In another aspect, the invention provides a method for extemporaneously reconstituting a mixture of compounds comprising filling at least two independent sub-containers with content in fixed dosages, arranging the sub-containers in a storage zone of a container, releasing the contents from each sub-container into the mixing chamber and extracting the final solution or suspension.

Additional objects, advantages and features of embodiments of the invention will become apparent to those skilled in the art upon examination of the description, or may be learned by practice of the invention.

### BRIEF DESCRIPTION OF THE DRAWINGS

Particular embodiments of the present invention will be described in the following by way of non-limiting examples, with reference to the appended drawings, in which:

FIG. 1 illustrates an exploded view drawing of an embodiment of the invention.

FIG. 2 illustrates an exploded view drawing of the embodiment of FIG. 1 wherein three of the sub-containers are interlocked.

FIG. 3 illustrates an exploded view drawing of the embodiment of FIG. 1 wherein four of the sub-containers are interlocked.

FIG. 4 illustrates a drawing of the embodiment of FIG. 1 wherein the sub-containers and the access port to the mixing chamber are locked within the storage zone of the container.

FIG. 5 illustrates a top-view perspective drawing of a sub-container according to an embodiment of the invention.

FIG. 6 illustrates a bottom-view perspective drawing of the embodiment of FIG. 5.

FIG. 7 illustrates a cross-sectional view drawing of the embodiment of FIG. 5.

FIG. 8 illustrates a partial cross-sectional view drawing of three interlocked sub-containers as illustrated in FIG. 2.

### DETAILED DESCRIPTION

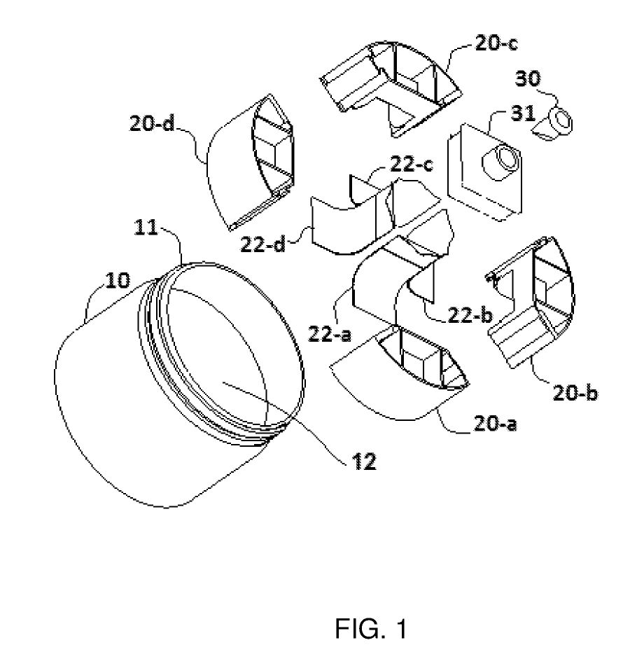

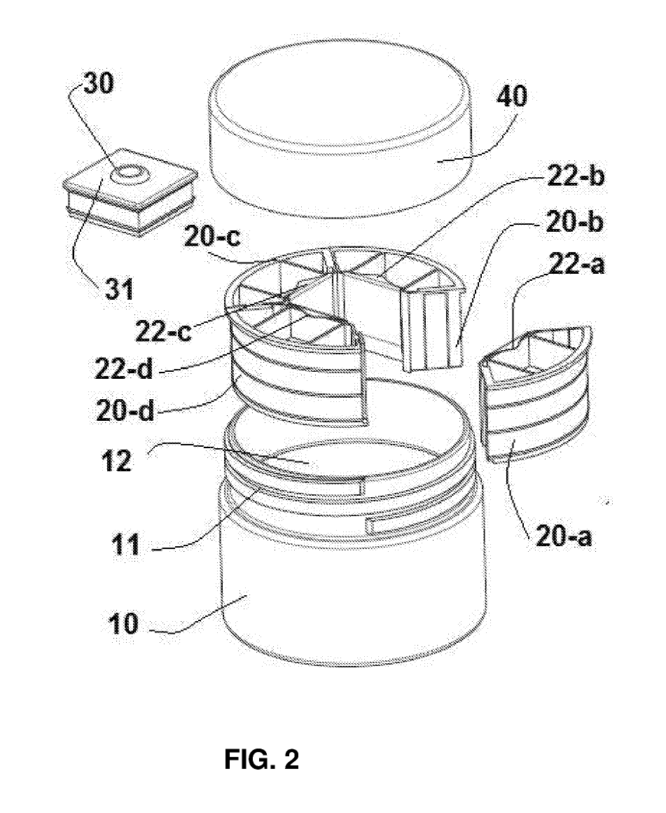

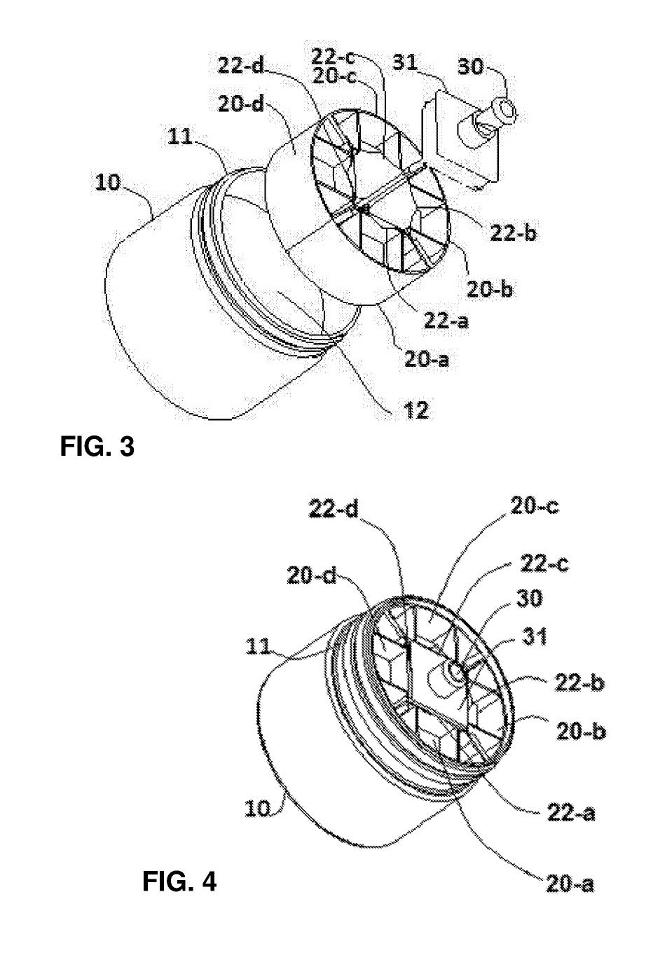

FIGS. 1-4 illustrate an embodiment of a container (10) according to the present invention.

In FIGS. 1-4, the container (10) has a substantially cylindrical shape. In other embodiments, the container (10) may be substantially cubic or spherical or may even be shapeless such as, for instance, a bag made of flexible plastic material.

In FIGS. 1-4, the container (10) comprises four equally sized independent sub-containers (20-a, 20b, 20c, 20d), i.e. not integral with each other or permanently attached. In other embodiments there may be only two, or three, or more sub-containers (20) per container (10). Furthermore, in some embodiments, the sub-containers (20) may have different sizes to receive different dosages of drugs.

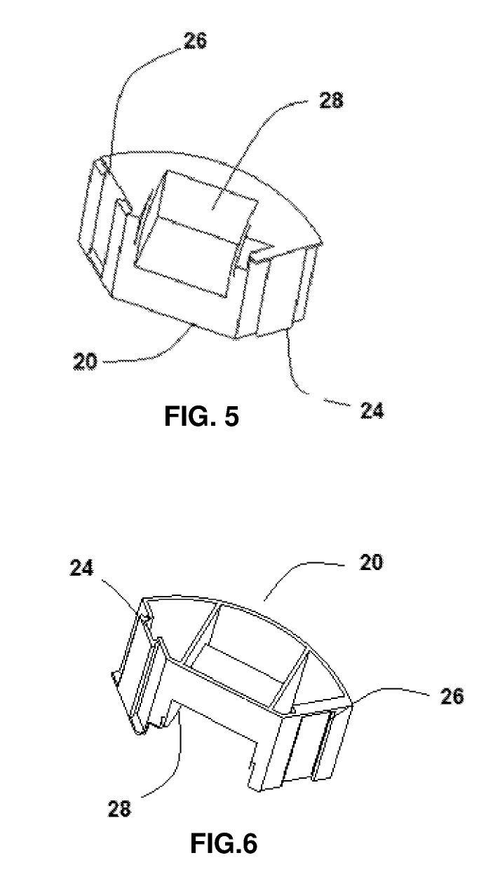

FIGS. 5, 6 and 8 illustrate the closeable storage cavity (28) comprised within each sub-container (20-a, 20-b, 20-c, 20-d) for receiving and storing a drug.

This closeable storage cavity (28) comprises a substantial opening which is directed substantially towards the mixing chamber (12) when the sub-container is in its normal position in the storage zone, thereby, ensuring the drugs fall into the mixing chamber (12) when the membrane (22) is removed by pulling its tab.

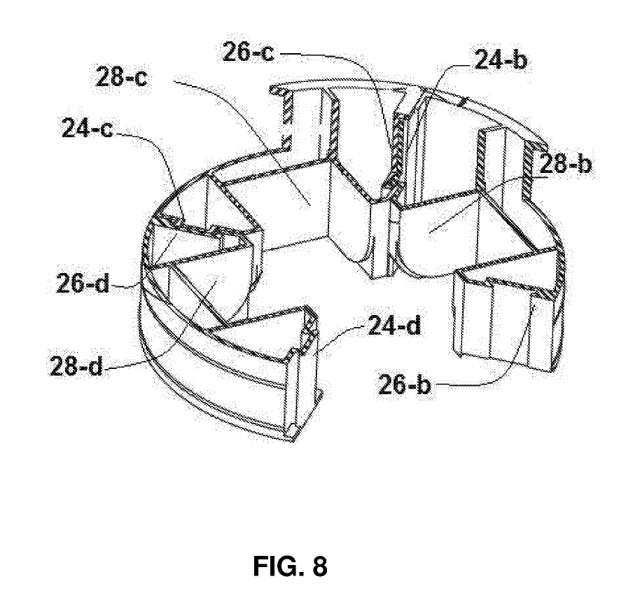

In one embodiment, the sub-containers may comprise rubber ridges to retain the sub-containers within the storage zone, as illustrated in FIG. 8. In other embodiments the interlocked sub-container assembly may comprise an external thread which allows the assembly to be screwed into its position in the storage zone. In another embodiment, the interlocked sub-container assembly is configured to sealingly close the passage between the mixing chamber and the opening.

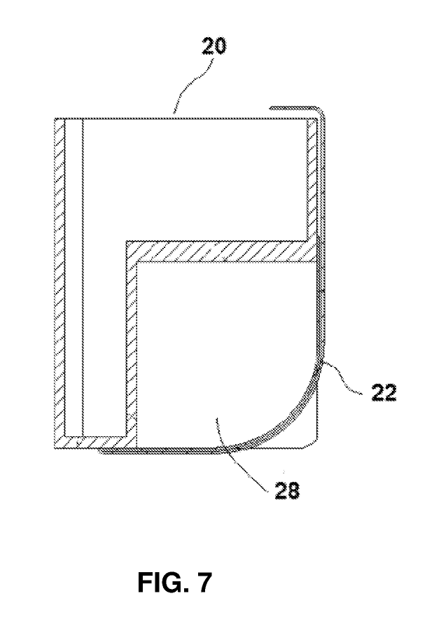

FIGS. 1 and 7 illustrate membranes (22-a, 22-b, 22-c, 22d) for sealing the sub containers (20-a, 20-b, 20-c, 20-d) and having tabs used for opening the sub-containers to release their content into the mixing chamber (12). In other embodiments, the closures used to retain the constituent drugs may be hatches that open by applying pressure on the upper side of the sub-container. In yet other embodiments, other types of closures may be used.

In this first embodiment, FIGS. 5 and 6 respectively illustrate a top and a bottom view of a sub-container where interlocking devices for interlocking with other sub-containers include interlocking male (24) and female (26) guide rails.

In another embodiment, the interlocking devices for interlocking sub-containers may comprise an additional circular skeletal frame into which the sub-containers are arranged.

In one embodiment, as illustrated in FIG. 8, the interlocking male (24) and female (26) guide rails may each comprise a protruding lip to prevent the sub-containers from overrunning the length of the guide rail when interlocked.

These lips may also act as impermeable barriers to prevent the mixture from seeping through the containers from the mixing chamber to the opening of the container. In other embodiments, alternative impermeable barriers may be used.

In this embodiment the access port (31) to the mixing chamber comprises a Luer valve (30) and said access port is placed centrally between the four sub-containers (20-a, 20-b, 20-c, 20-d) and attached thereto. In other embodiments, the access port may be a tap or a pouring spout or a tube or other port, such as those found in blood bags.

In one embodiment, the container (10) and all its parts may be designed for a single-use and disposed of after use. In other embodiments, the container and its components may be made of durable material and may be disassembled, washed, refilled, reassembled and reused.

In one embodiment, the rim of the container (10) may incorporate outer threads (11) for closing the container with a lid (40) with matching inner threads. In another embodiment, a child resistant safety cap may be used.

In yet other embodiments, the container may be designed for single use, in which case, it may be sealed with a membrane (not shown) prior to use, said membrane needing to be broken in order to use the container without providing a facility for closing the container after use.

In one embodiment, the container (10) or the sub-containers (20) may be vacuum-sealed or may use modified atmosphere packaging to further extend the shelf life or to protect the chemical properties of the constituent mixture components.

The sub-containers (20) may be stand-alone modules comprising a storage cavity (28) which can each be filled with one or more of the mixture constituent compounds, in set proportions, by remotely located compounds producing facilities and closed with a sealing membrane.

In one embodiment, the storage cavity (28) may comprise corners with angles of 90 degrees or greater in order for stored drugs to be released easily into the mixing chamber once the sealing membrane is removed. In another embodiment, the storage cavity (28) may comprise partially spherical inner walls. In yet another embodiment, the storage cavity (28) may be comprised of the sub-containers' entire inner space.

The sub-containers (20) are interlocked with each other and with the access port (31) to form an assembly. This assembly is inserted and locked within the storage zone of the container (10). A lid (40) may be used to close the assembled container which may be stored, ready for extemporaneous reconstitution of the mixture.

In some embodiments a diluent liquid may be added to the mixing chamber (12) prior to inserting the sub-container assembly into the container. In other embodiments, a diluent liquid may be one of the constituent compounds stored within one of the sub-containers. A further embodiment may be the addition of the diluent liquid to the mixing chamber via the Luer valve with a needleless syringe.

When the mixture is required, a user may simply break the membrane (22-a, 22-b, 22-c, 22-d) sealing each sub-container (20-a, 20-b, 20-c, 20-d) by pulling its tab, thus releasing the constituent compounds into the mixing chamber (12). The user may shake the container to mix the solution or suspension.

The mixed solution or suspension may be extracted using a needleless syringe to draw the solution through the Luer valve (30) comprised within the access port (30). The solution may be wholly or partially extracted over several periods depending on the solution or suspension consumer's requirements.

In another aspect, the invention provides a method for extemporaneously reconstituting a mixture comprising, filling at least two independent sub-containers with content in fixed dosages, arranging the sub-containers in a storage zone of a container and, at a later date or time, releasing the contents from each sub-container into the mixing chamber and extracting the final solution or suspension.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Reference signs related to drawings and placed in parentheses in a claim, are solely for attempting to increase the intelligibility of the claim, and shall not be construed as limiting the scope of the claim. Thus, the scope of the present invention should not be limited by particular embodiments, but should be determined only by a fair reading of the claims that follow.

1. A container comprising a hollow body and an opening; said hollow body comprising a mixing chamber and a storage zone, wherein the storage zone houses two or more independent sub-containers and said storage zone is situated between the opening and said mixing chamber.

2. A container according to claim 1, comprising a retainer for retaining the sub-containers within the storage zone.

3. A container according to claim 1, wherein the sub-containers comprise interlocking devices for interlocking with one another to form an assembly.

4. A container according to claim 3, wherein said assembly is configured to sealingly close the passage between the mixing chamber and the opening.

5. A container according to claim 1, wherein said sub-containers each comprise a closable storage cavity and a device to open said closable storage cavity to release the contents thereof into the mixing chamber.

6. A container according to claim 5, wherein the closeable storage cavity of each sub-container comprises an opening which is substantially directed towards the mixing chamber when the sub-container is in its normal position in the storage zone.

7. A container according to claim 5, wherein the closable storage cavity of the sub-container is configured to be closed with a sealing membrane.

8. A container according to claim 7 wherein said sealing membrane is configured to be removed by pulling a tab.

9. A container according to claim 1, comprising an access port to the mixing chamber.

10. A container according to claim 9, wherein said access port is configured for extraction of at least part of the content from the mixing chamber.

11. A container according to claim 9, wherein the access port is a Luer valve assembly arranged in the storage zone.

12. A container according to claim 9, wherein said access port is associated with the assembly of sub-containers.

13. A container according to claim 1, comprising a lid to close the opening of the container.

14. A method for extemporaneously reconstituting a mixture of compounds comprising,
filling at least two independent sub-containers with content in fixed dosages,
arranging the sub-containers in a storage zone of a container,
releasing the contents from each sub-container into the mixing chamber and
extracting the final solution or suspension.
